(19) United States
(12) Patent Application Publication
(10) Pub. No.: US 2022/0144588 A1
(43) Pub. Date: May 12, 2022

(54) ADJUSTABLE FORCE SAFETY BRAKES

(71) Applicant: Otis Elevator Company, Farmington, CT (US)

(72) Inventor: Javier Muñoz Sotoca, Rivas-Vaciamadrid (ES)

(21) Appl. No.: 17/392,902

(22) Filed: Aug. 3, 2021

(30) Foreign Application Priority Data
Nov. 6, 2020 (EP) 20382962.7

(51) Int. Cl. B66B 5/18; B66B 5/06

(52) U.S. Cl. CPC B66B 5/18; B66B 5/06

(57) ABSTRACT

An adjustable force safety brake for use in an elevator system. The adjustable force safety brake includes a safety block, first and second braking elements housed in the safety block and an electromagnet. The safety block includes a channel arranged to receive a guide rail of an elevator system in use. The first braking element is configured to move from an initial position into a position of engagement with the guide rail received in the channel to create a braking force, and the second braking element is configured to create an additional braking force on the guide rail when the first braking element is in the position of engagement. The electromagnet is operable to selectively produce a magnetic force which acts on the second braking element in a sideways direction away from the channel so as to reduce the additional braking force on the guide rail.

### FOREIGN PRIORITY

This application claims priority to European Patent Application No. 20382962.7, filed Nov. 6, 2020, and all the benefits accruing therefrom under 35 U.S.C. § 119, the contents of which in its entirety are herein incorporated by reference.

### TECHNICAL FIELD

This disclosure relates to an adjustable force safety brake for use in an elevator system, an elevator system including at least one adjustable force safety brake, and to a method for balancing braking forces in an elevator system.

### BACKGROUND

It is known in the art to mount safety brakes onto elevator components moving along guide rails, to bring the elevator component quickly and safely to a stop, especially in an emergency. In many elevator systems the elevator car is hoisted by a tension member with its movement being guided by a pair of guide rails. Typically, a governor is used to monitor the speed of the elevator car. According to standard safety regulations, such elevator systems must include an emergency braking device (known as a safety brake or “safety gear”) which is capable of stopping the elevator car from moving downwards, even if the tension member breaks, by gripping a guide rail. Safety brakes may also be installed on the counterweight or other components moving along guide rails.

Some safety brakes can be calibrated at the factory to set the braking force that should be applied during operation, but in reality there is no way to regulate the braking force applied during an emergency stop as the safety brake is gripping onto a guide rail which has inherent tolerances in its thickness and variations in its surface finish. In a conventional elevator system, side to side rotation of the elevator car can occur during a braking procedure and this can put passenger safety at risk. Rotation of the elevator car can occur due to various reasons, including passenger load distribution in the car, uneven braking forces being applied by the safety brakes, or a lack of synchronization of the safety actuators that operate the safety brakes.

Any side to side rotation or tilting of the elevator car during a braking operation may cause permanent damage to elevator components and require replacement of the elevator car. Uneven braking forces can, in the most drastic of circumstances, move a safety brake out of contact with a guide rail. This could lead to severe passenger injuries or even death.

There remains a need to improve safety brakes in elevator systems.

### SUMMARY

According to a first aspect of the present disclosure there is provided an adjustable force safety brake for use in an elevator system. The adjustable force safety brake comprises: a safety block, first and second braking elements housed in the safety block and an electromagnet; wherein the safety block includes a channel arranged to receive a guide rail of an elevator system in use; wherein the first braking element is arranged at a first side of the channel and the second braking element is arranged at a second side of the channel, opposite to the first side in a sideways direction; wherein the first braking element is configured to move from an initial position into a position of engagement with the guide rail received in the channel to create a braking force; wherein the second braking element is configured to create an additional braking force on the guide rail when the first braking element is in the position of engagement; and wherein the electromagnet is operable to selectively produce a magnetic force which acts on the second braking element in the sideways direction away from the channel so as to reduce the additional braking force on the guide rail.

It will be appreciated that the electromagnet can be operated to adjust the overall braking force applied by the safety brake by reducing the additional braking force created by the second braking element. The magnetic force acting on the second braking element tends to pull the second braking element in the sideways direction away from the channel. The safety brake may therefore be controlled to adjust the braking force during a braking operation. Such an adjustable force safety brake may be installed in place of one or more standard safety brakes so as to control deceleration relative to the guide rail and balance the braking forces being applied, e.g. during an emergency braking operation, for enhanced safety.

The second braking element may be configured in any suitable way enabling it to be acted on by the magnetic force of the electromagnet. For example, the second braking element may itself comprise an electromagnet. In some examples the second braking element is magnetic e.g. comprising one or more permanent magnets. In another set of examples, the second braking element is non-magnetic. It will be understood that the second braking element being non-magnetic means that it does not include any permanent magnet. Hence the second braking element is not itself magnetically attracted to a ferrous guide rail.

In some examples the second braking element at least partially comprises a ferromagnetic material. In some examples the second braking element wholly comprises a ferromagnetic material.

The inclusion of ferromagnetic material allows the second braking element to be magnetised in the presence of a magnetic field applied by the electromagnet, so that the magnetic force selectively pulls the second braking element in the sideways direction away from the channel. When the electromagnet is not operating, the ferromagnetic material is no longer magnetised and the additional braking force created by the second braking element is not reduced. The absence of a permanent magnet can make the safety brake smaller, cheaper and easier to adapt to different elevator systems requiring different levels of braking force.

In various examples, the second braking element may include any ferromagnetic material such as iron, cobalt, nickel, or an alloy of any of these metals. In at least some examples the second braking element is made wholly from a ferromagnetic material, such as steel.

The second braking element being configured to create an additional braking force on the guide rail, when the first braking element is in the position of engagement, means that the second braking element must also adopt a position of engagement with the opposite side of the guide rail. While the second braking element may be actively moved sideways into this position, this may make it difficult for the magnetic force to pull the second braking element sideways away from the channel. In at least some examples, the second braking element is configured to exert a resilient bias force in the sideways direction towards the channel. The second braking element may be mounted in the safety block with a separate resilient bias member, such as a spring, pushing the second braking element towards the channel. The magnetic force produced by the electromagnet may then overcome the resilient bias force to pull the second braking element back. However, it is preferable that the second braking element provides its own resilient bias force so as to reduce the number of parts and complexity of the safety brake.

In some examples the second braking element comprises one or more elastic elements so the second braking element is arranged in the safety block to exert a resilient bias force in the sideways direction towards the channel. This means that the second braking element has its own natural resilience tending to press the second braking element against the guide rail at the second side of the channel when the first braking element is in the position of engagement at the first side of the channel.

In any of the examples wherein the second braking element is configured to exert a resilient bias force in the sideways direction towards the channel, this ensures that the additional braking force is at a maximum by default if the electromagnet is not being operated, providing a failsafe. When the electromagnet is operated, the magnetic force acts on the second braking element in opposition to the resilient bias force but may not overcome the resilient bias force. Thus the magnetic force tending to pull the second braking element in the sideways direction can reduce its contact pressure against the guide rail, thereby reducing the additional braking force, but the second braking element may stay in physical contact with the guide rail. This ensures that there is some level of braking force being applied on both sides of the channel, which helps to keep the braking operation balanced and safe. In some examples the electromagnet is operable to produce a maximum magnetic force which is less than the resilient bias force, such that the second braking element tends to remain in physical contact with the guide rail when the first braking element is in the position of engagement. This helps to accommodate tolerances in guide rail thickness and ensure the safety brake works well within different elevator systems. In some examples, the maximum magnetic force produced by the electromagnet is about 1.4 kN.

Operation of the electromagnet may simply involve selectively turning on the electromagnet when it is desired to reduce the additional braking force. The electromagnet may be configured (e.g. based on the number of turns and/or wire thickness of its coils) to produce a magnetic force which is expected to be sufficient to make an appreciable difference to the contact pressure at the second side of the channel, and ideally without pulling the second braking element out of contact with the guide rail as discussed above. However, the inventors have recognised that a fixed magnetic force is not well suited to adapt to different braking situations. It may be possible to turn the electromagnet on and off in a controlled way that varies the magnetic force, e.g. pulsed operation of the electromagnet. However, it is desirable to be able to accurately control the level of the magnetic force produced by the electromagnet.

In some examples the electromagnet is operable to produce a variable magnetic force in a range from zero to a maximum magnetic force. This allows for a range of additional braking force to be applied, adjusting for a range of excessive braking forces. In such examples the safety brake may be able to provide a dynamic response to an excessive or uneven (i.e. unbalanced) braking situation. For example, the electromagnet may be operated by varying its power supply i.e. to vary the current through its coils. For example, the electromagnet may be operable to continuously vary the magnetic force so as to dynamically adjust the additional braking force during a braking operation. Varying the magnetic force may include both increasing and decreasing the magnet force so as to reduce and increase the additional braking force at different moments in time.

The electromagnet may be positioned anywhere in the safety block that allows its magnetic field to interact with the second braking element so as to produce a magnetic force acting in the sideways direction. The electromagnet and the second braking element may not be arranged in the same plane. In some examples the electromagnet is positioned in the safety block behind the second braking element in the sideways direction from the channel. This can help to ensure that the magnetic force is reliably produced. Moreover, the inventors have recognised that positioning the electromagnet behind the second braking element means that the electromagnet can conveniently act as a physical stop to prevent excessive movement of the second braking element in the sideways direction. In particular, the inventors have recognised that the second braking element may be susceptible to an initial rebound when the first braking element initially moves into its position of engagement and the guide rail is brought into contact with the second braking element. This may occur even in those examples wherein the second braking element comprises one or more elastic elements. The electromagnet can therefore act as a rebound stopper for the second braking element.

The electromagnet could be positioned in the safety block behind the second braking element almost in physical contact with the second braking element. However, such an arrangement could not easily accommodate tolerances in the guide rail or other variations in the safety brake. In some examples the electromagnet is positioned at a distance D1 behind the second braking element when the first braking element is in the position of engagement. The non-zero distance D1 ensures that there is space for the second braking element to shift or flex in the sideways direction, taking into account that the guide rail may have a different thickness in different elevator systems. However, it is preferable for the electromagnet to be positioned close to the second braking element to maximise its magnetic force, and to provide the rebound protection discussed above. In some examples the distance D1 has a maximum value of about 0.5 mm.

The first braking element is configured to create a braking force by moving into its position of engagement. This movement may take the form of wedging and hence the surface of the first braking element does not have to be a frictional surface, although it can help to have a knurled surface or the like to ensure a good wedging engagement. The second braking element, on the other hand, is stationary as the first braking element moves into its position of engagement and forces the guide rail into contact with the braking elements arranged on either side of the channel. The safety block may shift sideways to bring the second braking element into frictional contact with the guide rail. The normal reaction force at the surface of the second braking element creates the additional braking force, which will depend on the coefficient of friction at the surface. In some examples the second braking element comprises a frictional surface or brake shoe arranged to face the second side of the channel to provide frictional engagement with the guide rail. The frictional surface or brake shoe can be tailored to provide a desired coefficient of friction. For example, the frictional surface or brake shoe can be suitably treated or roughened for friction purposes. Furthermore, the surface area of the frictional surface or brake shoe can be made relatively large to enhance its braking effect.

The configuration of the first braking element should not affect the variability of the additional braking force created by the second braking element. Hence the first braking element may take any suitable form, such as a wedge or a roller running along an inclined surface. In at least some examples the first braking element is a roller including a knurled surface arranged to contact the guide rail when the first braking element moves into the position of engagement. This can help to ensure a reliable degree of engagement that ensures the second braking element is also brought into engagement with the guide rail.

It will be appreciated that an adjustable force safety brake as disclosed herein may be used with any moving component where it is desirable to be able to adjust the overall braking force e.g. to avoid excessive braking. In some elevator systems a component may be arranged to move along a single rail and hence only a single adjustable force safety brake may be needed. There is further disclosed herein an elevator system comprising: a component moving along a guide rail; an adjustable force safety brake as disclosed herein mounted to the component to apply a braking force to the guide rail; a safety controller operatively connected to the adjustable force safety brake; and at least one sensor operatively connected to the safety controller, wherein the at least one sensor is configured to detect an excessive braking force, and wherein the safety controller is configured, in response to detection of an excessive braking force, to selectively operate the electromagnet of the adjustable force safety brake.

However, an adjustable force safety brake as disclosed herein ideally finds use in a passenger elevator system where safety regulations typically require that the car, counterweight or balancing weight is guided by at least two guide rails. Such systems typically employ a pair of safety brakes for each component moving along a pair of guide rails. If these safety brakes are not properly synchronised in their operation, or the safety brakes apply uneven braking forces, then the braking operation can be unbalanced, and the component may be subject to a turning moment. By using at least one adjustable force safety brake in the pair of safety brakes, the braking force can be adjusted on at least one side of the component to restore balance.

According to a second aspect of the present disclosure there is provided an elevator system comprising: a component moving along a pair of guide rails; a pair of safety brakes mounted to the component to each apply a braking force to a respective one of the pair of guide rails when activated, wherein at least one of the pair of safety brakes is an adjustable force safety brake as disclosed herein; a safety controller operatively connected to the adjustable force safety brake; and at least one sensor operatively connected to the safety controller, wherein the at least one sensor is configured to detect the braking forces being applied by the pair of safety brakes, and wherein the safety controller is configured, in response to detection of the braking forces, to selectively operate the electromagnet of the adjustable force safety brake.

In some examples the at least one sensor may detect excessive and/or uneven braking forces being applied. It will be understood that an excessive braking force is one where the magnitude of the braking force is above a predefined threshold. An uneven braking force is one where braking is uneven between the pair of safety brakes, i.e. the braking forces are not the same on the two safety brakes.

It will be understood that operating of the electromagnet of the adjustable force safety brake produces a magnetic force that acts to reduce the additional braking force on one or both of the guide rails and this can be used to make the braking more even. The problem of unwanted side to side rotation of the component can therefore be avoided. The component may be an elevator car or other moving component in an elevator system such as a counterweight, balancing weight, or working platform. The elevator system may be roped or ropeless.

The safety controller may be configured to selectively operate the electromagnet by simply turning the electromagnet on and off. However, as discussed above, it is preferable that the magnetic force is not fixed and the electromagnet can be operated to produce a variable magnetic force. This can enable a dynamic response dependent on the level of braking forces detected. Thus, in some examples the safety controller is configured to vary the magnetic force produced by the electromagnet, in a range from zero to a maximum magnetic force, dependent upon the level of braking forces detected. For example, the safety controller may be configured to vary the electrical power supply to the electromagnet.

It will be understood that the level of braking forces is the level of excessive and/or uneven braking forces. The level of braking forces may be a detection of an absolute magnitude of braking force applied and may be compared to a threshold to determine whether a braking force is deemed as excessive. The level of braking forces may be a detection of an imbalance between the two braking forces of each respective safety brake.

In some examples, each of the pair of safety brakes is an adjustable force safety brake as disclosed here, and the adjustable force safety brakes are mounted to the component on opposite sides to receive a respective one of the pair of guide rails in the channel of each adjustable force safety brake. This means that the braking forces can be adjusted on both sides of the component.

In some examples the safety controller is configured to independently vary the magnetic force produced by the electromagnet of each of the pair of adjustable force safety brakes, in a range from zero to a maximum magnetic force, dependent upon the level of braking force respectively detected at opposite sides of the component. This means that the pair of adjustable force safety brakes can react quickly and accurately to balance the braking forces at opposite sides of the component and reduce the risk of rotation.

The at least one sensor may be positioned anywhere in the elevator system where it can sense the braking forces being applied by the pair of safety brakes. In some examples the at least one sensor is mounted on the component. In some examples the at least one sensor may be a single sensor that is configured to detect excessive and/or uneven braking forces either directly or indirectly. For example, a tilt sensor mounted centrally on the component may detect an imbalance or rotation resulting from uneven braking forces. In some examples the at least one sensor comprises a pair of sensors mounted on opposite sides of the component to detect excessive and/or uneven braking forces. The sensors may detect speed (e.g. using its differential to infer a deceleration resulting from a braking force) or acceleration/deceleration. In some examples the at least one sensor comprises a pair of accelerometers mounted on opposite sides of the component to detect excessive and/or uneven braking forces being applied between the pair of guide rails.

In some examples, the safety controller is remote from the adjustable force safety brake. For example, the safety controller may be located at a fixed position in the elevator system e.g. in the hoistway or in a machine room. In some examples, the connections between the at least one sensor, the safety controller and the adjustable force safety brake(s) comprise a travelling cable. In some examples, one or more of the connections between the at least one sensor, the safety controller and the adjustable force safety brake(s) are wireless.

In some examples, the safety controller may be located at the adjustable force safety brake. The connections between the at least one sensor, the safety controller and the adjustable force safety brake(s) may comprise fixed wiring. In some examples, the safety controller may be integrated into the adjustable force safety brake, e.g. on a local controller board.

In various examples, the safety controller may be a dedicated controller for the electromagnet. In other examples, the safety controller may be part of a main controller that receives signals from the at least one sensor in addition to receiving signals from other sensors in the elevator system that detect an over-speed or over-acceleration condition and cause the safety controller to operate any or all safety brakes, e.g. in an emergency stop situation. The emergency braking can be controlled so as not to be excessive or unbalanced using the adjustable force safety brake(s).

It will be appreciated that the elevator system may include more than one pair of safety brakes for a given component, such as an elevator car, for example in high rise buildings where more significant over speed may occur due to the increased drop. In at least some examples the elevator system comprises at least one further pair of safety brakes mounted to the component to each apply a braking force to a respective one of the pair of guide rails when activated. This means that one, or a pair of adjustable force safety brakes, can be combined with additional pair(s) of conventional safety brakes e.g. for higher duty elevator systems.

According to a third aspect of the present disclosure there is provided a method for adjusting braking forces in an elevator system, the method comprising: detecting, using at least one sensor the braking forces being applied by a pair of safety brakes mounted to a component moving along a pair of guide rails in an elevator system, wherein at least one of the pair of safety brakes is an adjustable force safety brake; and selectively operating an electromagnet in the adjustable force safety brake to change a braking force on the guide rail.

It will be appreciated that such a method allows adjustment of the magnetic force being produced so as to change a braking force on the guide rail, for example the additional braking force created by a second braking element on an opposite side of the guide rail to a first braking element creating a generally constant braking force. The electromagnet may be operated to change the braking force on both sides of the guide rail, or one side of the guide rail. In various examples the method comprises selectively operating an electromagnet in an adjustable force safety brake of the type as disclosed above.

As already discussed, selectively operating an electromagnet could comprise turning on and off a power supply to the electromagnet in response to the excessive and/or uneven braking. But it is preferable to vary the level of the braking force dependent on the level of excessive and/or uneven braking. This provides a dynamic approach to balancing braking forces in an elevator system.

In some examples the method includes: analysing the level of braking forces being applied by the pair of safety brakes; and varying the magnetic force produced by the electromagnet, in a range from zero to a maximum magnetic force, dependent upon the level of braking forces.

### BRIEF DESCRIPTION OF THE DRAWINGS

Certain examples of this disclosure will now be described, by way of example only, with reference to the accompanying drawings, in which:

FIG. 1 shows a schematic diagram of an elevator system employing a mechanical governor;

FIG. 2 shows a 3D perspective view of a prior art safety brake without a guide rail;

FIG. 3 shows a cross sectional view of the prior art safety brake in use with a guide rail;

FIG. 4 shows a 3D perspective view of an adjustable force safety brake according to an example of the present disclosure;

FIG. 5 shows a cross sectional view of the adjustable force safety brake in use with a guide rail;

FIG. 6A shows a cross sectional view of the adjustable force safety brake before a braking operation;

FIG. 6B shows a cross sectional view of the adjustable force safety brake at the beginning of a braking operation;

FIG. 6C shows a cross sectional view of the adjustable force safety brake during a braking operation;

FIG. 7 shows a schematic diagram of an elevator car employing a pair of adjustable force safety brakes according to an example of the present disclosure; and

FIG. 8 shows a flow chart representing a method of controlling the adjustable force safety brake according to an example of the present disclosure.

### DETAILED DESCRIPTION

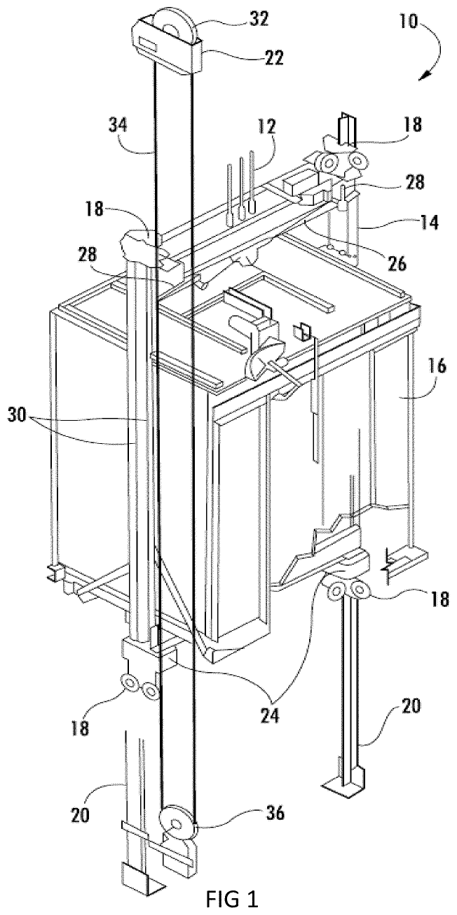

FIG. 1 shows an elevator system, generally indicated at 10. The elevator system 10 includes cables or belts 12, a car frame 14, an elevator car 16, roller guides 18, guide rails 20, a governor 22, and a pair of safety brakes 24 mounted on the elevator car 16. The governor 22 is mechanically coupled to actuate the safety brakes 24 by linkages 26, levers 28, and lift rods 30. The governor 22 includes a governor sheave 32, rope loop 34, and a tensioning sheave 36. The cables 12 are connected to the car frame 14 and a counterweight (not shown in FIG. 1) inside a hoistway. The elevator car 16, which is attached to the car frame 14, moves up and down the hoistway by a force transmitted through the cables or belts 12 to the car frame 14 by an elevator drive (not shown) commonly located in a machine room at the top of the hoistway. The roller guides 18 are attached to the car frame 14 to guide the elevator car 16 up and down the hoistway along the guide rails 20. The governor sheave 32 is mounted at an upper end of the hoistway. The rope loop 34 is wrapped partially around the governor sheave 32 and partially around the tensioning sheave 36 (located in this example at a bottom end of the hoistway). The rope loop 34 is also connected to the elevator car 16 at the lever 28, ensuring that the angular velocity of the governor sheave 32 is directly related to the speed of the elevator car 16.

In the elevator system 10 shown in FIG. 1, the governor 22, a machine brake (not shown) located in the machine room, and the safety brakes 24 act to stop the elevator car 16 if it exceeds a set speed as it travels inside the hoistway. If the elevator car 16 reaches an over-speed condition, the governor 22 is triggered initially to engage a switch, which in turn cuts power to the elevator drive and drops the machine brake to arrest movement of the drive sheave (not shown) and thereby arrest movement of elevator car 16. If, however, the elevator car 16 continues to experience an overspeed condition, the governor 22 may then act to trigger the safety brakes 24 to arrest movement of the elevator car 16 (i.e. an emergency stop). In addition to engaging a switch to drop the machine brake, the governor 22 also releases a clutching device that grips the governor rope 34. The governor rope 34 is connected to the safety brakes 24 through mechanical linkages 26, levers 28, and lift rods 30. As the elevator car 16 continues its descent, the governor rope 34, which is now prevented from moving by the actuated governor 22, pulls on the operating levers 28. The operating levers 28 actuate the safety brakes 24 by moving the linkages 26 connected to the lift rods 30, and the lift rods 30 cause the safety brakes 24 to engage the guide rails 20 to bring the elevator car 16 to a stop.

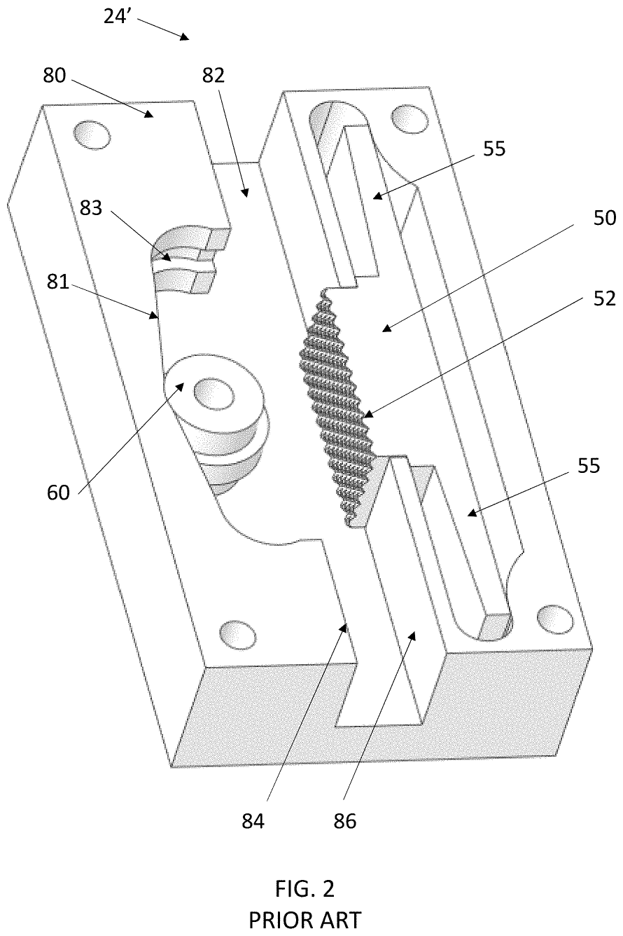

FIG. 2 shows a prior art safety brake 24′ as is known from ES1057303, the contents of which are hereby incorporated by reference. The safety brake 24′ includes a safety block 80, a first braking element 60, and a second braking element 50 with a frictional surface 52. The braking elements 50, 60 are housed in the safety block 80 on either side of a channel 82 arranged to receive a guide rail of an elevator system in use. The first braking element 60 is arranged at a first side 84 of the channel 82 and the second braking element 50 is arranged at a second side 86 of the channel 82, opposite the first side 84 in a sideways direction.

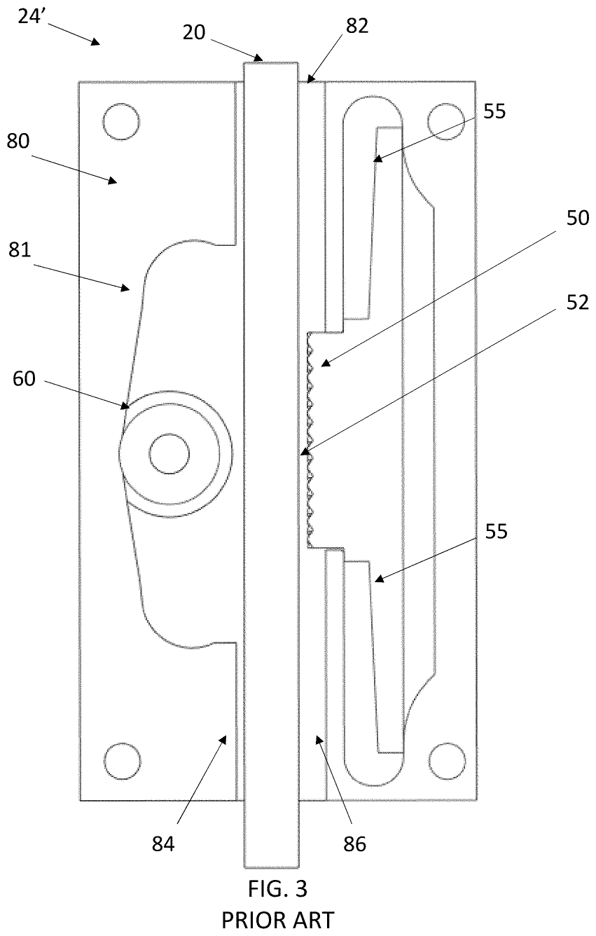

FIG. 3 shows the safety brake 24′ with the guide rail 20 received in the channel 82, i.e. during use of the safety brake 24′.

The first braking element 60 is a locking element which moves up or down into an engagement position to wedge against the guide rail 20 and produce a braking force on guide rail 20 e.g. when the car is moving too rapidly.

The first braking element 60 is a roller which sits in the safety block 80 on the first side 84 of the channel 82. It can be seen from FIGS. 2 and 3 that the roller 60 has a smaller outer diameter so that it easily moves along a ramp surface 81 of the safety block 80, and a larger inner diameter with a knurled surface for engaging with the guide rail 20. The larger diameter of the roller 60 fits into a groove 83 (seen in FIG. 2) so as not to frictionally engage with the safety block 80 when the roller 60 is moving to its engagement position. The safety block 80 has a ramp surface 81 including two oppositely inclining ramps which act to guide the roller 60 in both directions depending on the direction of braking.

The second braking element 50 is arranged at the second side 86 of the channel 82 in the safety block 80 to provide a frictional surface 52 on the opposing side of the guide rail 20 to that of the first braking element 60. The second braking element 50 includes two elastic elements 55 and a frictional surface 52 designed to act directly on the guide rail 20. The second braking element 50 is configured to exert a resilient bias force in the sideways direction onto the guide rail 20 by means of the elastic elements 55. It is designed to have a large area for the frictional surface 52, which engages with the guide rail 20 when the roller 60 moves to a position of engagement. The physical configuration of the two elastic elements 55 and the way in which they are housed in the safety block 80 allows for flexion and hence sideways movement of the second braking element 50.

FIGS. 2 and 3 show the safety brake 24′ before a braking operation. When the first braking element 60 is activated, for example by the governor rope 34 and mechanical linkages 26, levers 28, and lift rods 30 described in relation to FIG. 1, the roller 60 slides along the ramp surface 81 until it comes into contact with the guide rail 20, and then continues along the ramp surface 81 to become locked in full engagement, when the guide rail 20 is in full frictional contact with both the roller 60 and the frictional surface 52 of the second braking element 50. The braking force applied by the roller 60 is then partially absorbed by the second braking element 50 and spread through the safety block 80. When the roller 60 is fully engaged with the guide rail 20, the resilient bias force exerted by the second braking element 50 creates an additional braking force on the opposite side of the guide rail 20. It will be appreciated that no external activation is required for the second braking element 50 to exert its resilient bias force on the guide rail 20.

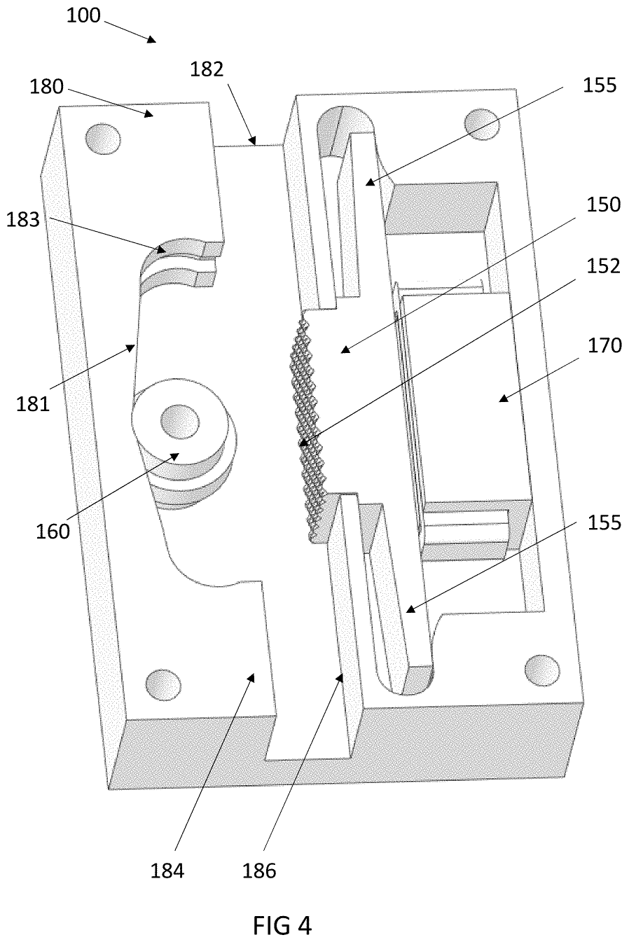

FIG. 4 shows an example according to the present disclosure of an adjustable force safety brake 100 comprising a safety block 180, a first braking element 160, a second braking element 150, and an electromagnet 170. The braking elements 150, 160 are housed in the safety block 180 on either side of a channel 182 arranged to receive a guide rail of an elevator system in use. The first braking element 160 is arranged at a first side 184 of the channel 182, and the second braking element 150 is arranged at a second side 186 of the channel 182, opposite to the first side 184 in a sideways direction.

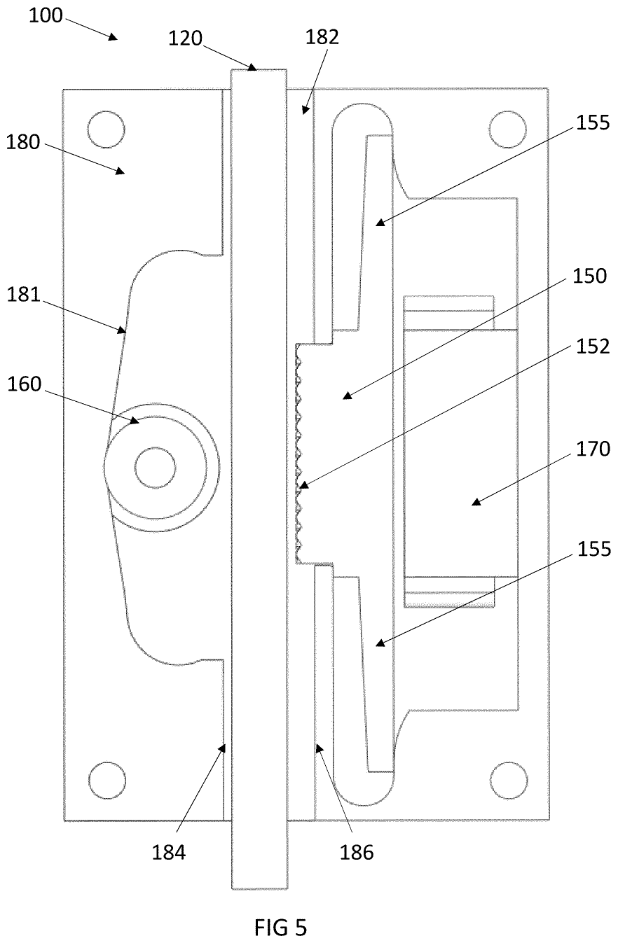

FIG. 5 shows the adjustable force safety brake 100 with a guide rail 120 received in the channel 182 during use.

With reference to both FIGS. 4 and 5, the adjustable force safety brake 100 is now described in more detail. The first braking element 160 is a locking element which is designed to move into a position to wedge against the guide rail 120 and produce a braking force against the guide rail 120. The first braking element 160 in this example is a roller 160. Whilst a roller 160 is shown in this example, a person skilled in the art will appreciate that any other suitable locking element such as a wedge may be used instead.

The first braking element 160 is a roller which sits in the safety block 180 on the first side 184 of the channel 182. The roller 160 has a smaller outer diameter so that it easily moves along a ramp surface 181 of the safety block 180. The roller 160 has a larger inner diameter with a knurled surface for engaging with the guide rail 120 that fits into a groove 183 (seen in FIG. 4) so as to move freely within the safety block 180. In this example, the safety block 180 has a ramp surface 181 including two oppositely inclining ramps which act to guide the roller 160 in both directions depending on the direction of braking.

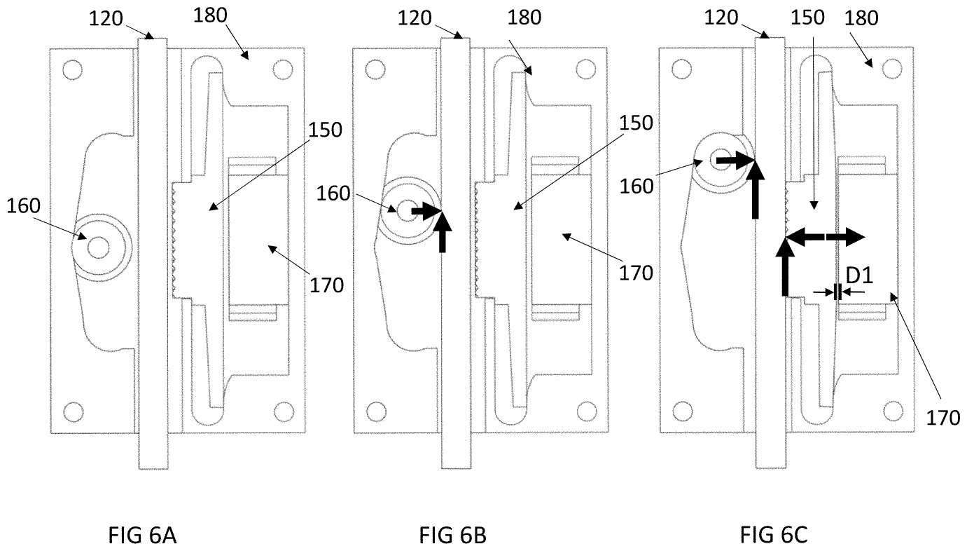

The second braking element 150 is arranged at the second side 186 of the channel 182 in the safety block 180 to provide a frictional surface 152 on the opposite side of the guide rail 120 to that of the first braking element 160. The second braking element 150 is configured to exert a resilient bias force in the sideways direction towards the channel 182, with a frictional surface 152 designed to act directly on the guide rail 120 in this example. In another example the second braking element 150 may have a separate brake shoe which acts as the frictional surface 152. The frictional surface 152 may be made of a material chosen to provide a suitable level of frictional engagement with the guide rail 120 and/or the frictional surface 152 may be suitably treated or contoured (as shown schematically) to aid frictional engagement with the guide rail 120. In this example the second braking element 150 comprises two elastic elements 155 which are housed in the safety block 180 allowing for flexion and hence sideways movement of the second braking element 150. The second braking element 150 is therefore designed to have a natural resilience to press the frictional surface 152 against the guide rail 120 when the roller 160 moves into a position of engagement, as is described below with reference to FIGS. 6A-6C.

When the adjustable force safety brake 100 is operated, the roller 160 moves along the ramp surface 181 to engage with the guide rail 120 and push the guide rail 120 into engagement with the frictional surface 152 of the second braking element 150.

The electromagnet 170 is positioned relative to the second braking element 150 such that, when the electromagnet 170 is operated, there is a magnetic force acting on the second braking element 150 to pull the second braking element 150 away from the channel 182 in the sideways direction. When the adjustable force safety brake 100 is installed in an elevator system so that a guide rail 120 is received in the channel 182, the electromagnet 170 is operable to pull the second braking element 150 away from the guide rail 120 and reduce the resilient bias force being applied on the guide rail 120, and therefore reducing the additional braking force provided by the second braking element 150. In this example the electromagnet 170 is placed behind the second braking element 150 in the sideways direction from the channel 182, and when operated pulls the second braking element 150 towards the electromagnet 170 and away from the guide rail 120. It will be appreciated by a person skilled in the art that another position for the electromagnet 170 could achieve the same result, within the design constraints of an elevator safety brake.

For the electromagnet 170 to produce a magnetic force which acts on the second braking element 150, it will be understood that the second braking element 150 should be susceptible to the magnetic field of the electromagnet 170. In some examples the second braking element 150 at least partially comprises a magnetic or ferromagnetic material. In this example the second braking element 150 is made of steel.

Advantageously, because the electromagnet 170 is located behind the second braking element 150 in the housing 180, the electromagnet 170 can act as a rebound stopper and prevent the second braking element 150 from moving sideways away from engagement with the guide rail 120 when braking first occurs. This will allow for a smooth and sustained initial braking, increasing the safety of the component being braked. For example, if the adjustable force safety brake 100 is located on an elevator car the safety of the passengers is improved.

In this example the second braking element 150 has a large surface area for the frictional surface 152, which engages with the guide rail 120. The second braking element 150 is shaped to include a large solid block in the centre behind the frictional surface 152, with the two thinner elastic elements 155 either side designed to flex sideways. This allows for a negligible deformation in the frictional surface 152 when pulled away from the guide rail 120 by the electromagnet 170, keeping parallelism and maintaining a small gap between the second braking element 150 and the electromagnet 170 behind.

The adjustable force safety brake 100 is shown in the process of a braking operation in FIGS. 6A, 6B and 6C, where the braking operation acts to prevent further downward movement of an elevator component.

FIG. 6A shows the adjustable force safety brake 100 in an initial position before a braking operation has commenced, and as positioned during the normal operation of the elevator. When the safety mechanism (not shown) is actuated to prevent further movement of the elevator component downwards in the hoistway, the roller 160 moves upwards from its initial position, along the surface of the ramp 181 where the roller 160 begins to engage with the guide rail 120 as shown in FIG. 6B. The normal force created by the contact of the roller 160 on the guide rail 120 (shown by the sideways force arrow) creates an upwards force (as shown by the arrow) and the roller 160 ascends freely along the ramp surface 181. The process is the same as for the prior art safety brake 24′ of FIGS. 2-3 where, if the car with the safety brake 24′ attached moves downwards, the relative movement of the guide rail 120 is in an upwards direction. Due to the knurled surface of the roller 160, the friction between the guide rail 120 and the larger diameter of the roller 160 is higher than the friction between the smaller diameter of the roller 160 and the safety block 180, and so the roller 160 spins and moves upwards. The roller 160 continues to move upwards into a position of engagement with the guide rail 120 as shown in FIG. 6C. The movement of the roller 160 and the guide rail 120 moves the safety block 180 into a position where the second braking element 150 and the roller 160 are applying opposing normal forces (as shown by the sideways force arrows pointing into the guide rail 120) onto each side of the guide rail 120, creating a braking force on both sides of the guide rail 120 (as shown by the upwards arrows in FIG. 6C).

Whilst in this example braking is shown to prevent downwards motion, it will be appreciated by a person skilled in the art that the principle of operation is similar for braking to prevent upwards motion, with the roller 160 instead moving downwards into a position of engagement with the guide rail 120.

As shown in FIG. 6C, when the adjustable safety brake 100 is in operation, sideways forces are applied normal to the guide rail 120 by the first and second braking elements 160, 150, producing an overall braking force in opposition to the movement of the safety block 180. By operating the electromagnet 170, the additional braking force applied to the guide rail 120 by the second braking element 150 can be reduced.

When the electromagnet 170 is operated, even when the magnetic force is at a maximum, some contact remains between the second braking element 150 and the guide rail 120. The maximum magnetic force of the electromagnet 170 is less than the resilient bias force of the second braking element 150. The second braking element 150 remains in physical contact with the guide rail 120 when the roller 160 is in the position of engagement. This can further prevent any bouncing of the second braking element 150 against the guide rail 120 and prevent the guide rail 120 moving away from contact with the roller 160 which could case interrupted braking forces and cause the elevator component to drop suddenly.

In this example, the electromagnet 170 is positioned in the safety block 180 behind the second braking element 150 so that when the roller 160 is in the position of engagement there is a non-zero distance D1 between the electromagnet 170 and the second braking element 150. This allows the second braking element 150 to move or flex as the guide rail 120 comes into engagement and to take into account tolerances of the whole system e.g. guide rail thickness, variations in the braking elements 150, 160, wear during use etc. and, to allow for rebound protection. In this example, the distance D1 is about 0.5 mm.

In this example, when the electromagnet 170 is not operated the maximum braking force is applied to the guide rail 120. This acts as a fail-safe option so if power to the adjustable force safety brake 100 is lost the biasing of the second braking element 150 will ensure that the maximum braking force is exerted on the guide rail 120.

In an example the electromagnet 170 is operable to produce a variable magnetic force, to provide a fully variable braking force on the guide rail 120, which can adjust to different levels of excessive and/or uneven braking.

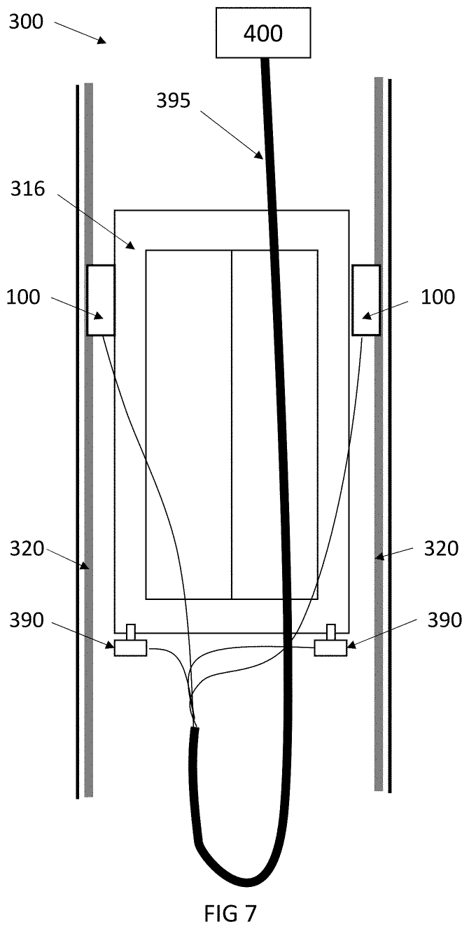

FIG. 7 shows an example of an elevator system 300 where two adjustable force safety brakes 100 are attached to an elevator car 316. Also shown in FIG. 7 are a plurality of guide rails 320, at least one sensor 390, a travelling cable 395, and a safety controller 400 located at a fixed position e.g. in the hoistway or in a machine room.

In this example, a pair of sensors 390 is shown mounted to the bottom of the elevator car 316. The sensors 390 are configured to detect excessive and/or uneven braking forces being applied by the pair of adjustable force safety brakes 100 on the elevator component, for example the elevator car 316. It will be appreciated by a person skilled in the art that various different types of sensors could be used, and various numbers of sensors could be used to detect excessive and/or uneven braking, for example a pair of accelerometers 390 located beneath the elevator car 316 to detect the movement of each side of the elevator car 316 as shown here.

In this example a pair of adjustable force safety brakes 100 are shown mounted to the elevator car 316. It will be appreciated that while a pair of safety brakes is usually required, it may be suitable to use a combination of an adjustable safety brake 100 and another design of safety brake known in the art, i.e. two different safety brakes.

The plurality of sensors 390 communicate with the safety controller 400 through the travelling cable 395, and the safety controller 400 communicates with the adjustable force safety brake 100 through the travelling cable 395. In this example the sensors 390 and the adjustable force safety brake 100 communicate through a separate safety controller 400 to the elevator system controller. In another example the safety controller 400 may be integrated into the main elevator system controller.

In this example the accelerometers 390 are located on each side of the elevator car 316. An unbalanced deceleration of the elevator car 316 can be detected and the safety controller 400 can decide automatically which adjustable force safety brake 100 should be instructed to operate the electromagnet 170 to reduce the braking force on the guide rail 320.

Whilst in this example the sensors 390 are only used to detect an excessive and/or uneven braking force, in another example the sensors 390 may also be used for other purposes within the elevator system 300, for example as part of a position reference system.

In the example where the electromagnet 170 of the adjustable force safety brake 100 is operable to produce a variable magnetic force, the safety controller 400 sends a signal to indicate how much current in the electromagnet 170 is required to restore balance to the elevator car 316.

The strength of the electromagnet 170 and/or its range of varying strengths can be designed with reference to the type of component to which the safety brake 100 will be mounted for braking. Some elevator systems 300 will have elevator cars 316 and counterweights of much larger sizes, and capable of big variations in load, whereas others will have far smaller and more regular loads. A large elevator car 316 designed to carry heavy goods, for example, may have very different braking requirements to that of a small number of people transporting elevator car 316.

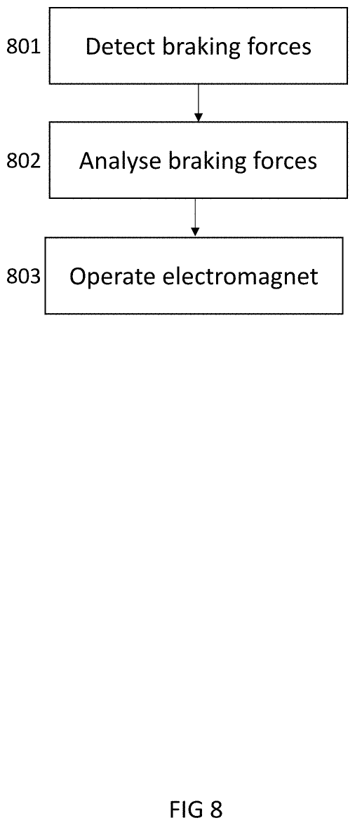

FIG. 8 shows a flow chart of a method for adjusting the braking force of an adjustable force safety brake 100 in an elevator system 300. The adjustable force safety brake 100 is controlled by the safety controller 400. In step 801 braking forces are detected to see whether excessive and/or uneven braking forces are being applied by a pair of safety brakes 24 including at least one adjustable force safety brake 100 mounted to a component e.g. moving along a pair of guide rails 320 in an elevator system. A signal is sent to the safety controller 400, for example via the travelling cable 395.

In this example, where the electromagnet 170 is operable to produce a variable magnetic force, in step 802 the safety controller 400 analyses the braking forces from the at least one sensor 390, e.g. calculating a corrected braking force to reduce or remove the excessive and/or uneven braking.

In step 803, the safety controller 400 then instructs the adjustable force safety brake 100 to operate the electromagnet 170 in the adjustable force safety brake 100 to change the additional braking force on the guide rail 320. In this example, the electromagnet 170 can vary the magnetic force produced by the electromagnet 170 depending on the level of excessive and/or uneven braking forces.

The sensor(s) 390 may be configured to continuously monitor the braking of the elevator car 316, and the safety controller 400 may provide continuous instructions to the electromagnet 170 of the adjustable force safety brake 100 to prevent any excessive and/or uneven braking from occurring.

It will be appreciated by those skilled in the art that this disclosure has been illustrated by describing one or more specific examples thereof, but is not limited to these examples; many variations and modifications are possible, within the scope of the accompanying claims.

What is claimed is:

1. An adjustable force safety brake (100) for use in an elevator system, the safety brake comprising:
a safety block (180), first and second braking elements (160, 150) housed in the safety block (180), and an electromagnet (170);
wherein the safety block (180) includes a channel (182) arranged to receive a guide rail (20;120;320) of an elevator system in use;
wherein the first braking element (160) is arranged at a first side (184) of the channel (182) and the second braking element (150) is arranged at a second side (186) of the channel (182), opposite to the first side (184) in a sideways direction;
wherein the first braking element (160) is configured to move from an initial position into a position of engagement with the guide rail (20;120;320) received in the channel (182) to create a braking force;
wherein the second braking element (150) is configured to create an additional braking force on the guide rail (20;120;320) when the first braking element (160) is in the position of engagement; and
wherein the electromagnet (170) is operable to selectively produce a magnetic force which acts on the second braking element (150) in the sideways direction away from the channel (182) so as to reduce the additional braking force on the guide rail (20;120;320).

2. The adjustable force safety brake (100) of claim 1, wherein the second braking element (150) comprises a ferromagnetic material.

3. The adjustable force safety brake (100) of claim 1, wherein the second braking element (150) is configured to exert a resilient bias force in the sideways direction towards the channel (182).

4. The adjustable force safety brake (100) of claim 3, wherein the electromagnet (170) is operable to produce a maximum magnetic force which is less than the resilient bias force such that the second braking element (150) tends to remain in physical contact with the guide rail (20;120;320) when the first braking element (160) is in the position of engagement.

5. The adjustable force safety brake (100) of claim 1, wherein the electromagnet (170) is operable to produce a variable magnetic force in a range from zero to a maximum magnetic force.

6. The adjustable force safety brake (100) of claim 1, wherein the electromagnet (170) is positioned in the safety block (180) behind the second braking element (150) in the sideways direction from the channel (182).

7. The adjustable force safety brake (100) of claim 1, wherein the electromagnet (170) is positioned at a distance (D1) behind the second braking element (150) when the first braking element (160) is in the position of engagement.

8. The adjustable force safety brake (100) of claim 1, wherein the second braking element (150) comprises a frictional surface (152) or shoe arranged to face the second side (186) of the channel (182) to provide frictional engagement with the guide rail (20;120;320).

9. An elevator system (10;300) comprising:
a component (16;316) moving along a pair of guide rails (20;120;320);
a pair of safety brakes (24) mounted to the component (16;316) to each apply a braking force to a respective one of the pair of guide rails (20;120;320) when activated, wherein at least one of the pair of safety brakes (24) is the adjustable force safety brake (100) of claim 1;
a safety controller (400) operatively connected to the adjustable force safety brake (100); and
at least one sensor (390) operatively connected to the safety controller (400), wherein the at least one sensor (390) is configured to detect the braking forces being applied by the pair of safety brakes (24), and wherein the safety controller (400) is configured, in response to detection of the braking forces, to selectively operate the electromagnet (170) of the adjustable force safety brake (100).

10. The elevator system of claim 9, wherein the safety controller (400) is configured to vary the magnetic force produced by the electromagnet (170), in a range from zero to a maximum magnetic force, dependent upon the level of the braking forces detected.

11. The elevator system of claim 9, wherein the adjustable force safety brakes (100) are mounted to the component (16;316) on opposite sides to receive a respective one of the pair of guide rails (20;120;320) in the channel (182) of each adjustable force safety brake (100).

12. The elevator system of claim 11, wherein the safety controller (400) is configured to independently vary the magnetic force produced by the electromagnet (170) of each of the pair of adjustable force safety brakes (100), in a range from zero to a maximum magnetic force, dependent upon the level of braking force respectively detected at opposite sides of the component (16;316).

13. The elevator system of claim 9, wherein the at least one sensor (390) comprises a pair of accelerometers mounted on opposite sides of the component (16;316) to detect excessive and/or uneven braking forces being applied between the pair of guide rails (20;120;320).

14. A method for adjusting braking forces in an elevator system (10, 300), the method comprising:
detecting, using at least one sensor (390), the braking forces being applied by a pair of safety brakes (24;100) mounted to a component (16;316) moving along a pair of guide rails (20;120;320) in an elevator system (10, 300), wherein at least one of the pair of safety brakes (24;100) is an adjustable force safety brake (100); and
selectively operating an electromagnet (170) in the adjustable force safety brake (100) to change its additional braking force on the guide rail (20;120;320).

15. The method of claim 14, further comprising:
analysing the level of braking forces being applied by the pair of safety brakes (24;100); and
varying the magnetic force produced by the electromagnet (170), in a range from zero to a maximum magnetic force, dependent upon the level of braking forces.
